(19) United States
(12) Patent Application Publication
(10) Pub. No.: US 2006/0281463 A1
(43) Pub. Date: Dec. 14, 2006

(54) Method for triggering handover of mobile terminal and system thereof

(75) Inventor: Man-Suk Yang, Gyeonggi-Do (KR)

Correspondence Address: BIRCH STEWART KOLASCH & BIRCH, PO BOX 747, FALLS CHURCH, VA, 22040-0747, US

(73) Assignee: LG Electronics Inc.

(21) Appl. No.: 11/448,687

(22) Filed: Jun. 8, 2006

(30) Foreign Application Priority Data
Jun. 10, 2005 (KR) 10-2005-0050018
Jun. 13, 2005 (KR) 10-2005-0050581

(51) Int. Cl. H04Q 7/20

(52) U.S. Cl. 455/442

(57) ABSTRACT

A method for triggering a communication event of a mobile terminal is provided. The method includes transmitting a message from the mobile terminal to a radio network controller (RNC) to request a specific event be performed; and re-transmitting the message from the mobile terminal to the RNC based on a predetermined condition exists.

This application claims priority to Korean Patent Applications No. 10-2005-0050018 filed on Jun. 10, 2005 and 10-2005-0050581 filed on Jun. 13, 2005 in Korea, the entire contents of both which are hereby incorporated by reference in their entirety.

### BACKGROUND OF THE INVENTION

1. Field of the Invention

The present invention relates to a mobile terminal, and more particularly, to a method and system for triggering a handover operation of a mobile terminal.

2. Description of the Related Art

A mobile terminal utilizing a universal mobile telecommunications system (UMTS) and a wideband code division multiple access (WCDMA) technique performs a handover operation when a signal strength of a currently controlling base station weakens. In addition, the handover operation is an operation where the mobile terminal switches control to a new base station when moving into a new cell. Thus, in the handover operation, the mobile terminal maintains call communication while traveling between different cells. In more detail, when the mobile terminal is moving away from a first base station towards a second base station, the signal strength between the first base station and the mobile terminal becomes weaker, and the signal strength between the second base station and the mobile terminal becomes stronger. Thus, when the signal strength between the second base station and the mobile terminal is greater than the signal strength between the first base station and the mobile terminal, the mobile terminal is switched to the second base station.

For example, FIG. 1 is a flow diagram illustrating a handover operation in accordance with the related art. As shown in FIG. 1, when the mobile terminal is transitioning between first and second cells corresponding to first and second base stations and the signal strength between the mobile terminal and the first base station falls below a threshold level, the mobile terminal transmits a message such as a handover measurement report to a radio network controller (RNC) requesting a handover operation (EVENT 1B) to the second base station having a stronger signal strength.

Then, the RNC updates an active set of the mobile terminal in response to the handover measurement report. The active set is updated to include the new base station B. The RNC then transmits an active set update message including the new second page station B to the mobile terminal. Further, the handover operation is a soft handover (SHO) operation. Upon receiving the active set update message from the RNC, the mobile terminal transmits an active set update complete message to the RNC to complete the handover operation to the new second base station having the stronger signal strength.

In addition, during the handover operation, the mobile terminal transmits the measurement report to the RNC only once. Thus, as shown in the bottom of FIG. 1, if the measurement report message is not processed by the RNC or is lost, the call may be disconnected. That is, the signal strength between the first base station and the mobile terminal may become so weak that the call is disconnected before the handover operation is successfully completed. U.S. Pat. Nos. 6,615,044, 6,845,238 and 6,879,831 also disclose related art handover methods.

### SUMMARY OF THE INVENTION

Therefore, one object of the present invention is to efficiently perform a handover operation by re-transmitting the handover request message to the RNC if a response to the message is not received from the RNC during a predetermined time.

Another object of the present invention is to transmit a handover request message to the RNC requesting handover to a second base station when the mobile terminal had recently been handed over to a first base station, but that the second base station now has the stronger signal strength.

To achieve at least the above objects in whole or in parts, the present invention provides in one aspect a method for triggering a communication event of a mobile terminal, the method comprising: transmitting a message from the mobile terminal to a radio network controller (RNC) to request a specific event be performed; and re-transmitting the message from the mobile terminal to the RNC based on a predetermined condition.

According to another aspect, the present invention provides a communication system comprising: a mobile terminal configured to wirelessly communication with another mobile terminal; a plurality of base stations configured to control the mobile terminal as the mobile terminal passes through the respective base stations; and a radio network controller (RNC) configure to control the plurality of base stations and the mobile terminal, wherein the mobile terminal transmits a handover request message to the RNC to request a handover event be performed, and re-transmits the handover request message to the RNC based on a predetermined condition.

According to another aspect, the present invention provides a mobile terminal comprising: a physical layer for measuring signal strengths received from a plurality of base stations; a radio link control (RLC) layer for transmitting/receiving a message to a radio network controller (RNC) requesting the mobile terminal be handed over to a new base station; and a radio resource control (RRC) layer for transmitting a handover measurement report to the RNC through the RLC layer when a handover event occurs based on a signal strength measured at the physical layer, and re-transmitting the handover measurement report to the RNC based on a predetermined condition.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements, wherein:

FIG. 1 is a flow diagram showing a method for triggering a handover operation of a mobile terminal in accordance with the related art;

FIG. 2 is an overview showing a system for triggering a handover operation of a mobile terminal in accordance with the present invention;

FIG. 3 is a flow diagram showing a method for triggering a handover operation of a mobile terminal in accordance with a first embodiment of the present invention;

FIG. 4 is a flow diagram showing a method for triggering a handover operation of a mobile terminal in accordance with a second embodiment of the present invention; and

FIG. 5 is a block diagram showing a system for triggering a handover operation in accordance with the second embodiment of the present invention.

### DETAILED DESCRIPTION OF THE INVENTION

A method for triggering a handover operation of a mobile terminal in accordance with preferred embodiments of the present invention will now be described with reference to the drawings.

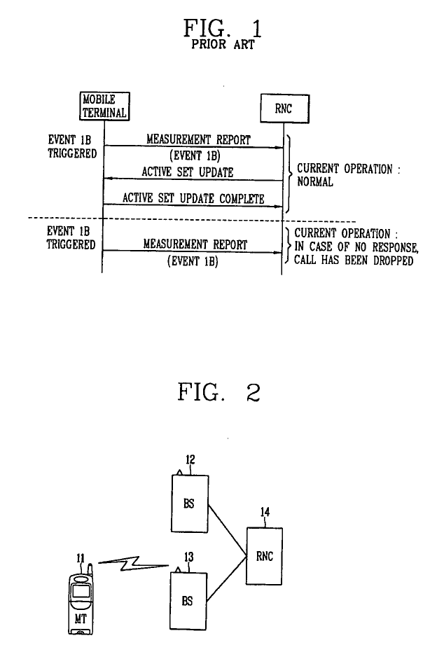

In more detail, FIG. 2 is an overview showing a system for triggering a handover operation of a mobile terminal in accordance with the present invention. As shown, the system includes a mobile terminal (MT) 11, a first base station (BS) 12, a second base station (BS) 13 and an RNC 14. The RNC 14 controls the BSs 12 and 13, and FIG.2 illustrates the MT 11 being in communication with the second BS (cell) 13.

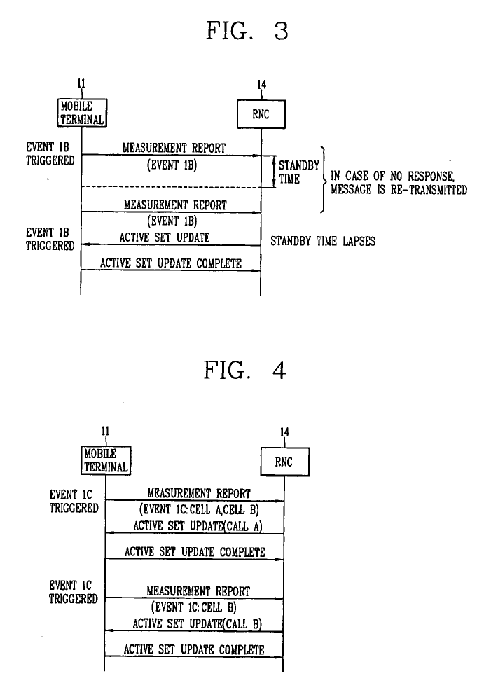

Turning next to FIG. 3, which is a flow diagram showing a method for triggering a handover operation of a mobile terminal in accordance with a first embodiment of the present invention. FIG. 2 will also be referred to in this description. As shown in FIG. 3, the MT 11 transmits a message requesting a handover operation to the RNC 14 when a handover event occurs based on a signal strength between the MT 11 and the BS 13. For example, if the MT 11 is moving towards the BS 12, the signal strength between the MT 11 and the BS 13 will become weaker and the signal strength between the MT 11 and BS 12 will become stronger. Thus in this instance, the MT 11 requests a handover operation to the BS 12 by transmitting a measurement report message to the RNC 14.

That is, the handover operation refers to a function that when the mobile terminal in a call communication state is out of a pertinent base station service area (cell boundary) and moves to a neighbor base station service area, the signal strength between the pertinent base station and the mobile terminal becomes weak. Therefore, to maintain the current call state, the MT 11 is automatically tuned to a new traffic channel of the neighboring base station via the handover operation. That is, the MT 11 is wirelessly linked to the neighboring base station to maintain the communication link.

In addition, as shown in FIG. 3, the MT 11 determines whether or not a response has been received from the RNC 14 within a pre-set standby time (e.g., one or two seconds). If a response is not received within the pre-set standby time, the MT 11 re-transmits the message requesting the handover operation to the RNC 14.

However, if a response to the handover measurement report is received from the RNC 14 within the pre-set time, the MT 11 performs the handover operation. In more detail, the RNC 14 updates an active set of the MT 11 in response to the handover measurement report and transmits the updated active set to the MT 11. In the example above, when the MT 11 is moving towards the BS 12, the active set would include the BS 12 in place of the BS 13 so that the MT 11 switches over to the BS 12. Namely, the MT 11 releases the radio link with the BS 13 and wirelessly links with the BS 12. In addition, when the MT 11 successfully receives the active set update message from the RNC 14 and successfully performs the handover operation, the MT 11 transmits an active set update complete message to the RNC 14, thereby terminating the triggering of the handover operation of the MT 11.

Thus, when the handover measurement report message transmitted by the MT 11 to the RNC 14 is lost due to a network error, for example, such that the RNC 14 does not receive the message, the RNC cannot transmit an appropriate response to the MT 11. However, in accordance with the embodiment of the present invention shown in FIG. 3, when there is no response to the handover event (EVENT 1 B) during a specific time, the MT 11 re-transmits the message requesting the handover operation to thereby prevent the call from being dropped.

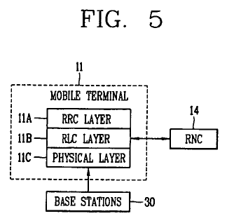

Turning next to FIG. 4, which is a flow diagram showing a method for triggering a handover operation of a mobile terminal in accordance with a second embodiment of the present invention. In FIG. 4, the signal strength between the MT 11 and its controlling base station is becoming weaker, so the MT 11 transmits a measurement report to the RNC 14 requesting a handover procedure. In this instance, the measurement report includes information (e.g., a signal strength) of first and second base stations A and B. Then, as shown in FIG. 4, the RNC 14 transmits an active set update message to the MT 11 including the base station A, because at that time, the base station A has the stronger signal strength (i.e., the signal strength of the base station A is greater than the signal strength of the base station B).

However, in the related art, the RNC 14 allows the handover operation only with respect to the first base station A having the strongest signal strength. Therefore, when a leaving triggering condition with respect to the second base station B is not satisfied (e.g., the signal strength between the MT 11 and the second base station B is not below a predetermined threshold), the RNC 14 does not allow a periodical report of the handover event (EVENT 1C) for the base station B because the handover has occurred with the Base Station A (i.e., the RNC has transmitted the active set update message including the base Station A to the MT 11). That is, the RNC 14 has determined the signal strength of the base station A is the strongest and thus does not allow the MT 11 to connect with the base station B (the RNC does not allow the periodical report of the handover event C regarding the base station B).

Thus, even though the signal strength of the second base station B turns out to be the strongest immediately after the RNC 14 has just determined the base station A has the strongest signal strength, the MT 11 does not transmit a handover measurement report for handover with the second base station B. Therefore, the MT 11 cannot perform handover with the second base station B. Thus, when the signal strengths of the other neighboring base stations than the second base station B become weak, the MT 11 can not handover to the base station B and the call is dropped.

However, in accordance with an embodiment of the present invention, the call is prevented from being dropped by automatically wirelessly linking the MT 11 with the second base station B when the signal strengths of the other neighboring base stations become weak. That is, as shown in FIG. 4, the active set update message sent from the RNC 14 to the MT 11 only includes the base station A (i.e., the second base station B is not included in the active set). In this instance, and when the leaving triggering condition with respect to the base station B is not met, and when the signal strength of the second base station B becomes the strongest, the MT 11 re-transmits a measurement report for handover with the second base station B even though the RNC 14 does not allow periodically reporting of the handover event (EVENT 1C). In more detail, after the initial handover operation to the base station A in which the base station A has the stronger signal strength than the base station B, the handover event 1C occurs again because the signal strength of the base station has become the strongest. In this instance, the MT retransmits a measurement report including the base station B to the RNC to perform handover with respect to the base station B.

Turning next to FIG. 5, which is a block diagram showing a system for triggering a handover operation in accordance with the second embodiment of the present invention. As shown, the system includes the MT 11 for receiving signals from a plurality of base stations 30, for measuring a strength of the received signals, and for transmitting a handover measurement report requesting a handover operation with a second base station even though the RNC 14 does not allow periodical reporting on the handover event (EVENT 1C), the second base station does not meet the leaving triggering condition and when only the first base station is included in an active set after a handover event occurs with respect to the first and second base station. The system also includes the RNC 14 that wirelessly links the MT 11 to the second base station B by updating the active set of the MT 11, in response to the handover measurement report.

Further, as shown in FIG. 5, the MT 11 includes a physical layer 11C for measuring each signal strength received from the plurality of base stations 30, a radio link control (RLC) layer 11B for transmitting/receiving a message for performing the handover operation between the MT 11 and base stations, and a radio resource control (RRC) layer 11A for transmitting a handover measurement report to the RNC 14 through the RLC layer 11B when a handover event occurs based on the signal strength measured at the physical layer 11C, and re-transmitting the measurement report informing about the handover event to the RNC 14 when the handover event reoccurs when a leaving triggering condition is not met.

Further, the RNC 14 analyzes the measurement report received from the RLC layer 11B of the MT 11, and if the handover performing condition is met based on the analysis result, the RNC 14 transmits an active set update message (namely, a handover authentication message) to the RLC layer 11C. The MT 11 receives the active set update message through the RLC layer 11B, and the RRC layer 11A performs the handover operation according to the active set update message. After the MT 11 completes the handover operation, the MT 11 transmits an active set update complete message (namely, a handover complete message) to the RNC 14, thereby completing the handover operation of the MT 11.

Further, in the present invention, by defining a specific parameter (e.g., reporting interval, reporting amount, etc.) for a plurality of communication events not yet defined, besides the handover event, a message requesting a communication event can be re-transmitted.

As so far described, the method and system for triggering handover of the mobile terminal in accordance with the present invention have many advantages. For example, when there is no response to the handover message request during a pre-set time from the RNC, the message is re-transmitted, thereby preventing a call from being dropped. In addition, after the first base station and the mobile terminal are wirelessly linked, and when the signal strength of the second base station becomes the strongest at a time when the RNC 14 does not permit periodical reporting on the handover event (EVENT 1C) and the second base station does not meet the leaving triggering condition, the mobile terminal transmits the measurement report including the second base station to the RNC, so that the mobile terminal is wirelessly linked with the second base station when the signal strengths of the other neighboring base stations are weak, thereby preventing a call from being dropped.

In addition, the mobile terminal can be applied in a mobile communication system such as the UMTS (Universal Mobile Telecommunications System), the WCDMA (Wideband Code Division Multiple Access) system, etc. Further, the handover operation is a soft handover in which the mobile terminal maintains communication with its original controlling base station until the communication has been completed with the new base station.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for triggering a communication event of a mobile terminal, said method comprising:
transmitting a message from the mobile terminal to a radio network controller (RNC) to request a specific event be performed; and
re-transmitting the message from the mobile terminal to the RNC based on a predetermined condition.

2. The method of claim 1, wherein the re-transmitting step retransmits the message if the predetermined condition is that a response to the message is not received from the RNC during a pre-set time.

3. The method of claim 1, wherein the message is a handover request message and the specific event is a soft handover event.

4. The method of claim 3, wherein when a signal strength between the mobile terminal and a first base station is smaller than a signal strength between the mobile terminal and a second base station, the mobile terminal transmits the handover request message to the RNC requesting the mobile terminal be handed over to the second base station.

5. The method of claim 4, wherein the mobile terminal re-transmits the handover request message from the mobile terminal to the RNC if the predetermined condition is that a response to the handover request message is not received from the RNC during a pre-set time.

6. The method of claim 3, wherein the handover request message includes signal strengths of at least first and second base stations, and the RNC transmits an active set update message to the mobile terminal including the first base station having a higher signal strength than the second base station.

7. The method of claim 6, wherein the mobile terminal re-transmits the handover request message including the signal strength of the second base station, if the predetermined condition is that the handover event reoccurs while a leaving triggering condition between the mobile terminal and the second base station is not satisfied.

8. The method of claim 2, wherein the message transmitted by the mobile terminal to the RNC is a measurement report, and the message transmitted from the RNC to the mobile terminal is an active set update message.

9. A communication system, comprising:
a mobile terminal configured to wirelessly communication with another mobile terminal;
a plurality of base stations configured to control the mobile terminal as the mobile terminal passes through the respective base stations; and
a radio network controller (RNC) configure to control the plurality of base stations and the mobile terminal,
wherein the mobile terminal transmits a handover request message to the RNC to request a handover event be performed, and re-transmits the handover request message to the RNC based on a predetermined condition.

10. The system of claim 9, wherein the mobile terminal retransmits the message if the predetermined condition is that a response to the message is not received from the RNC during a pre-set time.

11. The system of claim 9, wherein when a signal strength between the mobile terminal and a first base station is smaller than a signal strength between the mobile terminal and a second base station, the mobile terminal transmits the handover request message to the RNC requesting the mobile terminal be handed over to the second base station.

12. The system of claim 9, wherein the handover request message transmitted to the RNC includes signal strengths of at least first and second base stations of the plurality of base stations, and the RNC transmits an active set update message to the mobile terminal including the first base station having a higher signal strength than the second base station.

13. The system of claim 12, wherein the mobile terminal re-transmits the handover request message including the signal strength of the second base station, if the predetermined condition is that the handover event reoccurs while a leaving triggering condition between the mobile terminal and the second base station is not satisfied.

14. The system of claim 9, wherein the message transmitted by the mobile terminal to the RNC is a measurement report, and the message transmitted from the RNC to the mobile terminal is an active set update message.

15. A mobile terminal comprising:
a physical layer for measuring signal strengths received from a plurality of base stations;
a radio link control (RLC) layer for transmitting/receiving a message to a radio network controller (RNC) requesting the mobile terminal be handed over to a new base station; and
a radio resource control (RRC) layer for transmitting a handover measurement report to the RNC through the RLC layer when a handover event occurs based on a signal strength measured at the physical layer, and re-transmitting the handover measurement report to the RNC based on a predetermined condition.

16. The mobile terminal of claim 15, wherein the RRC layer retransmits the message if the predetermined condition is that a response to the message is not received from the RNC during a pre-set time.

17. The mobile terminal of claim 15, wherein when a signal strength between the mobile terminal and a first base station is smaller than a signal strength between the mobile terminal and a second base station, the RRC layer transmits the handover request message to the RNC requesting the mobile terminal be handed over to the second base station.

18. The mobile terminal of claim 15, wherein the handover request message transmitted to the RNC includes signal strengths of at least first and second base stations of the plurality of base stations, and the RNC transmits an active set update message to the mobile terminal including the first base station having a higher signal strength than the second base station.

19. The mobile terminal of claim 18, wherein the RRC layer re-transmits the handover request message including the signal strength of the second base station, if the predetermined condition is that the handover event reoccurs while a leaving triggering condition between the mobile terminal and the second base station is not satisfied.

20. The mobile terminal of claim 15, wherein the message transmitted by the mobile terminal to the RNC is a measurement report, and the message transmitted from the RNC to the mobile terminal is an active set update message.
